(19) United States
(12) Patent Application Publication
(10) Pub. No.: US 2019/0176675 A1
(43) Pub. Date: Jun. 13, 2019

(54) MOTOR VEHICLE EQUIPPED WITH A STRONGBOX AND METHOD FOR SECURING A VALUABLE ITEM IN A MOTOR VEHICLE

(71) Applicant: FORD GLOBAL TECHNOLOGIES, LLC, Dearborn, MI (US)

(72) Inventor: Kevin Michael Lysik, Lathrup Village, MI (US)

(21) Appl. No.: 15/840,637

(22) Filed: Dec. 13, 2017

(51) Int. Cl. B60P 3/03; B60R 25/01; B60R 7/04

(52) U.S. Cl. CPC B60P 3/03; B60R 7/043; B60R 25/01

(57) ABSTRACT

A motor vehicle includes a strongbox, a strongbox door, a dedicated locking mechanism for the strongbox door and a mounting feature securing the strongbox to the motor vehicle. A related method for securing a valuable item in a motor vehicle is also disclosed.

### TECHNICAL FIELD

This document relates generally to the motor vehicle equipment field, and more particularly, to a motor vehicle equipped with a strongbox providing added security for a valuable item as well as to a method for securing a valuable item in a motor vehicle.

### BACKGROUND

It is known in the art to equip a motor vehicle with a storage compartment in a glovebox and/or a center console that may only be accessed through a locking glovebox door or cover. Unfortunately, while glovebox doors and console covers may be locked, they do not provide high security. As a consequence they may be relatively easily opened and the contents can be removed by unauthorized persons.

This document relates to a motor vehicle incorporating a strongbox with an electronically controlled dedicated locking mechanism linked to the vehicle's security system. Advantageously, the strongbox is resistant to forced opening and may be permanently attached to the motor vehicle in a manner that provides substantial additional security over state-of-the-art locking gloveboxes and center console compartments.

### SUMMARY

In accordance with the purposes and benefits described herein, a motor vehicle is provided. That motor vehicle includes or comprises a strongbox, a strongbox door, a dedicated locking mechanism for the strongbox door and a mounting feature securing the strongbox in the motor vehicle.

More specifically, the mounting feature may secure the strongbox directly to a sheet metal structure of the motor vehicle. In one of many possible embodiments, the mounting feature secures the strongbox to a floor pan of the motor vehicle. In another of the many possible embodiments, the mounting feature secures the strongbox directly to a frame of the motor vehicle. In yet another embodiment, the mounting feature secures the strongbox directly to a cross car beam of the motor vehicle. In one or more of these embodiments, the mounting feature may be at least one weld permanently securing the strongbox to any part of the metal superstructure of the motor vehicle.

The strongbox may be mounted under a seat of the motor vehicle. In other embodiments, the strongbox may be mounted in a console of the motor vehicle. In still other embodiments, the strongbox may be mounted in a glovebox of the motor vehicle. In still other embodiments, the strongbox may be mounted in or on a cargo floor of the motor vehicle.

In substantially any of these embodiments, the strongbox and the strongbox door may both be made from a high strength steel material resistant to being opened and damaged without the dedicated locking mechanism being properly activated.

That dedicated locking mechanism may be an electronic latch module. Further, the dedicated locking mechanism may be controlled by a controller. That controller may be configured to only open the dedicated locking mechanism when a key of the motor vehicle is in the motor vehicle. This increases the security of the strongbox.

In accordance with an additional aspect, a method is provided for securing a valuable item in a motor vehicle. That method comprises the steps of locating a strongbox within the motor vehicle and permanently securing the strongbox to a metal superstructure of the motor vehicle.

The method may further include the step of welding the strongbox to the superstructure. Further, the method may include providing the strongbox with a strongbox door. Still further, the method may include providing a dedicated locking mechanism for the strongbox door.

The method may further include the step of making the strongbox and the strongbox door from a high grade steel that is resistant to tampering and provides additional security. Still further, the method may include using an electronic latch module for the dedicated locking mechanism of the strongbox.

In the following description, there are shown and described several preferred embodiments of the motor vehicle equipped with a new and improved strongbox. As it should be realized, the motor vehicle and the related method for securing a valuable item in a motor vehicle, are capable of other, different embodiments and their several details are capable of modification in various, obvious aspects all without departing from the motor vehicle and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the motor vehicle and the method of securing a valuable item in a motor vehicle and together with the description serve to explain certain principles thereof.

FIG. 1a is schematic view of a motor vehicle showing a strongbox permanently mounted by welds to a floor pan underneath a front seat.

FIG. 1b is a perspective view of the strongbox that may be directly secured and even permanently attached to a sheet metal structure or the metal superstructure of the motor vehicle.

FIG. 2 illustrates a motor vehicle wherein the strongbox is mounted within a console and welded to the floor pan in the motor vehicle.

FIG. 3 is a schematic block diagram of the security system of the motor vehicle including a dedicated locking mechanism for the strong box in the form of an electronic latch module responsive to a controller of the motor vehicle.

Reference will now be made in detail to the present preferred embodiments of the motor vehicle and the related method for securing a valuable item in a motor vehicle, examples of which are illustrated in the accompanying drawing figures.

### DETAILED DESCRIPTION

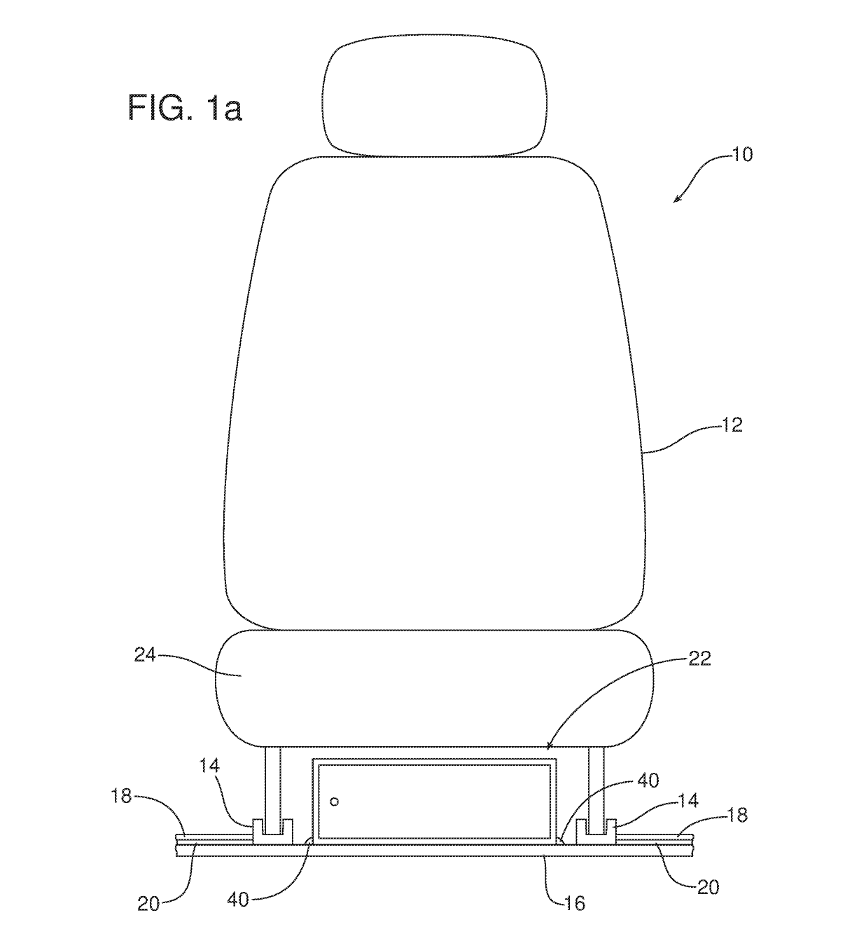

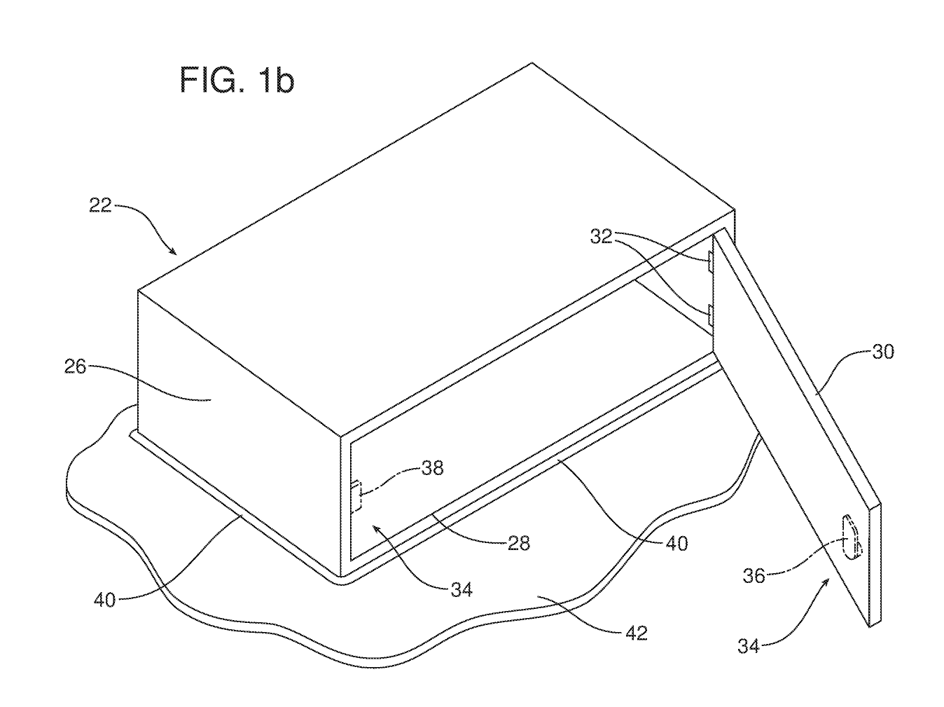

Reference is now made to FIG. 1a illustrating a portion of an interior of a motor vehicle 10 including a front seat 12 held on a seat position adjustment rack 14 that is fixed to the floor pan 16 of the motor vehicle. That floor pan 16 is covered by a decorative carpet 18. A layer of sound deadening insulation 20 is provided between the carpet and the floor pan 16. A strongbox, generally designated by reference numeral 22, is provided between the bottom seat cushion 24 and the floor pan 16.

As should be appreciated from reviewing FIGS. 1a and 1b, the strongbox 22 comprises an enclosure 26 having a single access opening 28 and a strongbox door 30, pivotally attached to the enclosure 26 and adapted for opening and closing the closure.

The strongbox 22, including enclosure 26 and the strongbox door 30, are preferably made from a high strength material resistant to tampering and theft. Preferably a high strength steel material is utilized. For added security the strongbox door 30 may be secured to the housing or enclosure 26 by an internal hinge 32 hidden from view when the strongbox door 30 is closed.

A dedicated locking mechanism, generally designated by reference numeral 34 is provided for the strongbox door 30. The deadbolt 36 of the dedicated locking mechanism is made from a high strength steel as is the striker 38 that receives the deadbolt.

A mounting feature 40 secures the strongbox 22 in the motor vehicle 10. In the illustrated embodiment, the mounting feature 40 comprises at least one weld that permanently attaches the enclosure 26 of the strongbox 22 to the floor pan 16. That weld 40 may be hidden from view by the overlying carpet 18 if desired.

It should be appreciated that FIG. 1a illustrates a single embodiment of the motor vehicle 10 and should be considered illustrative rather than limiting in scope. As more generally illustrated in FIG. 1b, the mounting feature 40 may be utilized to secure the strongbox 22 directly to substantially any sheet metal structure 42 of the motor vehicle 10 including the metal superstructure or any part of that metal superstructure including, for example, the frame or the cross car beam of the motor vehicle.

As illustrated in FIG. 1a, the strongbox 22 is mounted under the front seat 12 of the motor vehicle. Other mounting locations are possible. Thus, as more broadly illustrated in FIG. 1b, the strongbox 22 may be mounted to any sheet metal structure 42 such as to a cross car beam in a glovebox or on or in a cargo floor of the motor vehicle.

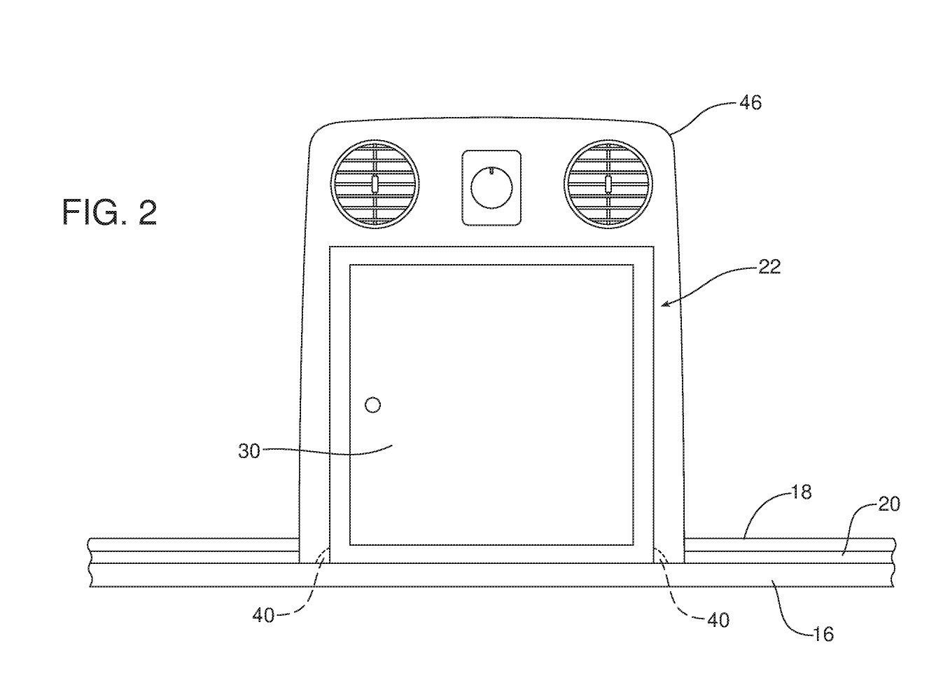

As illustrated in FIG. 2, the strongbox 22 may be mounted in a center console 46 of the motor vehicle 10. Such a mounting position would be particularly useful in larger vehicles such as a pickup truck. In any and all embodiments, the strongbox 22 may be permanently fixed to the superstructure of the motor vehicle by any appropriate mounting feature 40 for that purpose.

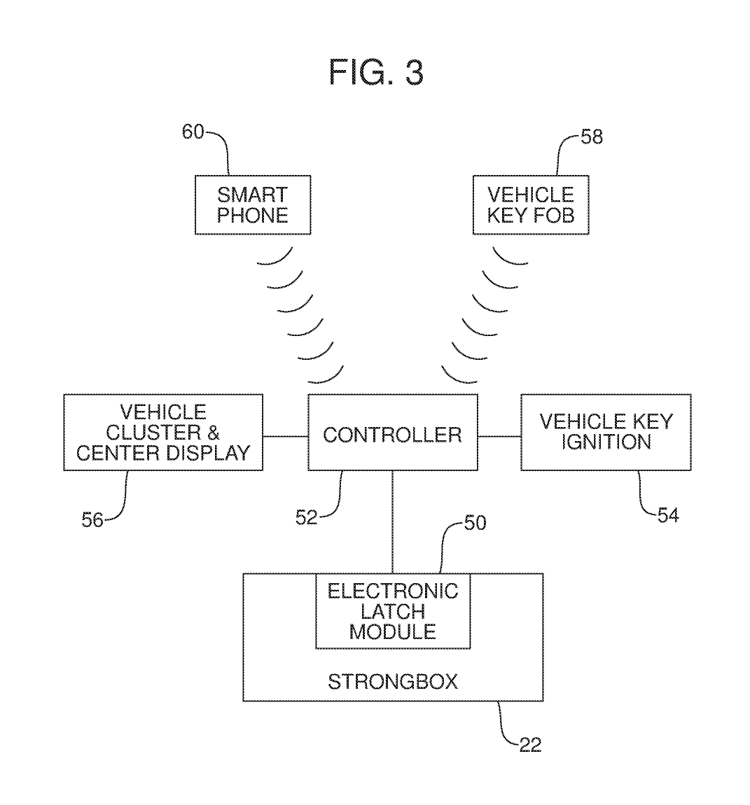

As illustrated in FIG. 3, the dedicated locking mechanism 34 may comprise an electronic latch module 50. That electronic latch module 50 may be linked to the motor vehicle security system through the motor vehicle security system controller 52. The controller 52 may comprise a computing device such as a dedicated microprocessor or an electronic control unit (ECU) operating in accordance with instructions from appropriate control software. Thus, the controller 52 may comprise one or more processors, one or more memories and one or more network interfaces all in communication with each over a communication bus.

As further illustrated in FIG. 3, the controller 52 may be connected to the vehicle key ignition 54, where the motor vehicle includes a state-of-the-art key controlled ignition switch, as well as to the vehicle cluster and center display 56 by a communication bus. The controller 52 may also be configured for wireless communication with a vehicle key fob 58, matched by security code to the motor vehicle 10 and/or a smart phone 60 adapted to communicate with the controller 52 through a Bluetooth or other wireless connection.

In one possible embodiment of the invention, the controller 52 is adapted or configured to only open the dedicated locking mechanism 34 (the electronic latch module 50 of the embodiment illustrated in FIG. 3) when the key of the motor vehicle is in the motor vehicle 10. Accordingly, the controller 52 must detect the presence of the vehicle key fob 58 within the motor vehicle 10 before the controller will unlatch the electronic latch module 50 to allow one to open the strongbox door 30 and access the contents of the strongbox 22. This provides an added level of security and limited access to any valuable item that might be stored in the strongbox 22. Thus, as illustrated in FIG. 3, the controller 52 may be configured to open the electronic latch module 50 in a motor vehicle 10 incorporating a traditional key when that traditional key is in the vehicle key ignition 54.

In contrast, where the motor vehicle includes a keyless ignition system, the controller 52 must detect the presence of the vehicle key fob 58 within the motor vehicle before the controller will release the electronic latch module 50 through operator input via Bluetooth from the smart phone 60 or via human interface input through the vehicle cluster and/or center display 56 of the motor vehicle. In still other possible embodiments, the vehicle key fob 58 may include one or more buttons that may be depressed to open the electronic latch module 50.

An enhanced level of security is provided for any valuable item held in the strongbox 22 in a number of different ways. Advantageously, the strongbox 22, including the enclosure 26 and the strongbox door 30, are made from high strength materials resistant to tampering and damage. The internal hinge 32 for the strongbox door 30 and the deadbolt 36 and striker 38 of the dedicated locking mechanism 34 are both protected from prying and concealed within the strongbox when the strongbox door 30 is closed and locked.

As a further advantage, the strongbox 22 is permanently attached by the mounting feature 40 to the sheet metal structure/metal superstructure of the motor vehicle including, for example, the floor pan 16, the frame and the cross car beam of the motor vehicle. As a further security feature, the controller 52 is adapted or configured to only release the dedicated locking mechanism 34 to allow the opening of the strongbox door 30 when the motor vehicle key, either in traditional or key fob form, is present in the motor vehicle.

Considered together, these features provide enhanced security for any valuable item held in the strongbox 22 that far exceeds that provided by standard, state-of-the-art locking gloveboxes and center console storage compartments.

The foregoing has been presented for purposes of illustration and description. It is not intended to be exhaustive or to limit the embodiments to the precise form disclosed. Obvious modifications and variations are possible in light of the above teachings. For example, the electronic latch module 50 may be provided with a mechanical override if desired. All such modifications and variations are within the scope of the appended claims when interpreted in accordance with the breadth to which they are fairly, legally and equitably entitled.

What is claimed:

1. A motor vehicle, comprising:
a strongbox;
a strongbox door;
a dedicated locking mechanism for said strongbox door; and
a mounting feature securing said strongbox in said motor vehicle.

2. The motor vehicle of claim 1, wherein said mounting feature secures said strongbox directly to a sheet metal structure of said motor vehicle.

3. The motor vehicle of claim 1, wherein said mounting feature secures said strongbox directly to a floor pan of said motor vehicle.

4. The motor vehicle of claim 1, wherein said mounting feature secures said strongbox directly to a frame of said motor vehicle.

5. The motor vehicle of claim 1, wherein said mounting feature secures said strongbox directly to a cross car beam of said motor vehicle.

6. The motor vehicle of claim 1, wherein said strongbox is mounted under a seat of said motor vehicle.

7. The motor vehicle of claim 1, wherein said strongbox is mounted in a console of said motor vehicle.

8. The motor vehicle of claim 1, wherein said strongbox is mounted in a glovebox of said motor vehicle.

9. The motor vehicle of claim 1, wherein said strongbox is mounted in a cargo floor of said motor vehicle.

10. The motor vehicle of claim 1, wherein said mounting feature is at least one weld permanently securing said strongbox to a metal superstructure of said motor vehicle.

11. The motor vehicle of claim 1, wherein said strongbox and said strongbox door are made from high-strength steel.

12. The motor vehicle of claim 11, wherein said dedicated locking mechanism is an electronic latch module.

13. The motor vehicle of claim 11, wherein said dedicated locking mechanism is controlled by a controller.

14. The motor vehicle of claim 13, wherein said controller is configured to only open said dedicated locking mechanism when a key of said motor vehicle is in said motor vehicle.

15. A method for securing a valuable item in a motor vehicle, comprising:
locating a strongbox within said motor vehicle; and
permanently securing said strongbox to a metal superstructure of said motor vehicle

16. The method of claim 15, including welding said strongbox to said metal superstructure.

17. The method of claim 16, including providing said strongbox with a strongbox door.

18. The method of claim 17, including providing a dedicated locking mechanism for said strongbox door.

19. The method of claim 18, including making said strongbox and said strongbox door from a high-strength steel.

20. The method of claim 19, including using an electronic latch module for said dedicated locking mechanism.
